(19) United States
(12) Patent Application Publication
(10) Pub. No.: US 2002/0190520 A1
(43) Pub. Date: Dec. 19, 2002

(54) Color encoding pre-printed media with a monochromatic printer

(76) Inventors: Michael R. Garross, Beach Park, IL (US); Anthony R. Brown, Grayslake, IL (US); Gerhard Cless, Northbrook, IL (US)

Correspondence Address: Welsh & Katz, Ltd., Eric D. Cohen, 22nd Floor, 120 South Riverside Plaza, Chicago, IL, 60606, US

(21) Appl. No.: 10/172,427

(22) Filed: Jun. 14, 2002

Related U.S. Application Data
(60) Provisional application No. 60/298,987, filed on Jun. 18, 2001.

(51) Int. Cl. B42D 15/00

(52) U.S. Cl. 283/67

(57) ABSTRACT

Information is encoded on media having color elements. The elements may have a varying shape, orientation, or color to form a pictorial, geometric or other pattern. Selected color elements are overprinted to alter the visual geometry or color so as to encode predetermined information.

### CROSS-REFERENCE TO RELATED APPLICATIONS

This application claims the benefit of priority from copending provisional patent application Serial No. 60/298,987 filed on Jun. 18, 2001, entitled “Color-Encoding Print Media With A Monochromatic Printer.” Provisional patent application Serial No. 60/298,987 is incorporated herein by reference in its entirety.

### FIELD OF THE INVENTION

The present invention relates to color encoding of tickets, tags, cards, labels and other media using a monochromatic printer.

### BACKGROUND OF THE INVENTION

Tags, labels, and cards printed by thermal transfer printers are referred to as “media.” A typical example of a media is an adhesive-backed label that may have dimensions of four inches by six inches, by way of example. A hang tag is another form of media, and is commonly attached to luggage. Normally imprinted on the media are indicia that relate information, such as the identity of the owner and where the luggage is to be sent. The hang tag may include a perforation and notches by which the tag may be attached to the luggage.

Another form of media is the “RFID” (radio frequency identification) label, which has greatly enhanced the versatility of the label as a medium of communication. Also referred to as a “smart label,” the RFID label includes an antenna electrically connected to a microchip, both of which are embedded in a media, such as a label, by interleaving the combination into its structure. In contrast to the standard label, which cannot be altered once the indicia are printed thereon, the RFID label is “dynamic” in that it can be programmed and re-programmed as many times as is necessary by means of instructions usually sent remotely by radio waves. Typical applications include toll-way pass systems (“I-Pass™”), which allow a vehicle to pass a tollgate without stopping, and which deduct the charge from the owner's account. Another application, “SpeedPass™,” is an automatic retail gasoline refueling system wherein the identity of the car owner is automatically conveyed to the gas pumping system, and which also causes a deduction of the charge from the owner's account. McDonald's Corporation is also using the SpeedPass™ system for a quick-charge system for its fast-food product. A fourth application is an RFID card access system for controlling entry to secure facilities.

Offset printing and letterpress are processes that are seldom used for the on-demand printing of labels because labels and tags and the like are typically needed in real time without the delay that older more traditional methods cause. Faster print technologies used to print media are the dot matrix, ink jet, laser, and thermal printing. Thermal printing has proved to be one of the best on-demand media printing means. The two processes of thermal printing are set forth in this description.

Direct thermal printing utilizes a paper or other material that changes in contrast or in color as a result of application of heat. Printing is accomplished by a thermal print head which includes linear arrays of small resistive heating elements, which typically range from 100 to 600 per inch, and which are aligned perpendicular to the path of the paper as it passes beneath the print head. The electrical energizing of a single resistive heating element will cause a small black dot to form on the heat-sensitive paper. Activation of a linear array of such elements in a vertical direction will form a fine black line, which may be a single line of a bar code or a constituent of the vertical bar of the numeral “1” or the letter “I.” If all of the elements of a thermal print head are activated, a solid black line will be deposited on the heat-sensitive paper. As the paper traverses beneath the print head, the line will progressively take the shape of a black rectangle as the paper moves beneath the print head, thus obscuring whatever lies beneath the print head.

Thermal transfer printing uses a print head similar to that used for direct thermal printing. The difference is that the media upon which the printing is done is not sensitive to heat. The impression on the media is made by means of an intermediary ribbon that passes between the print head and the media, and which carries a dry thermal transfer ink. As each resistive element of the print head is activated, it melts a contiguous area of the ribbon to deposit a dot upon the print media. Alternatively, a multi-color ribbon will deposit a selected dot of color on the media.

Both direct thermal printing and thermal transfer printing systems in common use offer a resolution of 203 dpi (dots per inch), and when finer resolution is required, up to 600 dpi. Print speed typically varies from two to ten inches per second, and the print widths typically vary from 2 to 8.5 inches, depending upon the machine. Further, the size may be “scalable,” that is, the size can be adjusted to provide font sizes that can be selected in a range from 6 points to 600 points.

A miniature, portable interactive thermal transfer print machine that is capable of printing in scalable fonts is described in U.S. Pat. No. 5,267,800 of common ownership herewith, and is incorporated herein by reference in its entirety. The implementation of the invention set forth herein is preferably by thermal transfer printing, although direct thermal printing can be used as well.

### BRIEF DESCRIPTION OF THE DRAWINGS

FIG. 1 depicts schematically a specific embodiment of a printer and printer-controller assembly utilized by the invention.

FIG. 1A depicts the indicia-receiving surface of a luggage label having preprinted color areas ready for encoding according to the invention.

FIG. 2 shows the encoding of the preprinted areas of FIG. 1A.

FIG. 3 shows a modification of a corner of the label of FIG. 1A.

FIG. 4 depicts an RFID label with an indicia-receiving surface, and having preprinted areas ready for encoding according to the invention.

FIG. 5 is a view of the interior configuration of the RFID label shown by FIG. 4.

FIGS. 6 and 7 show two consecutive stages of the encoding of a luggage hang tag.

FIG. 8 is a view of a label showing another embodiment of an encodable configuration according to the invention.

FIGS. 9 and 10 are respective “before-and-after” views of a label in which an alphanumeric symbol is applied according to the invention.

FIGS. 11-13 depict the stages of encoding of predetermined information on a preprinted label, resulting in the formation of words.

FIG. 14 shows a segment of a two-color preprinted area of a label ready for encoding.

FIG. 15 shows the encoding of the label of FIG. 14 that results in the defining of two alphanumeric characters.

FIGS. 16-20 depict the various effects that can be achieved by encoding information according to the invention;

FIG. 21 shows a pictorial effect that may be achieved by means of the invention in the encoding of media, and

FIGS. 22 and 23 depict the encoding of an alphanumeric character according to the invention.

### DETAILED DESCRIPTION

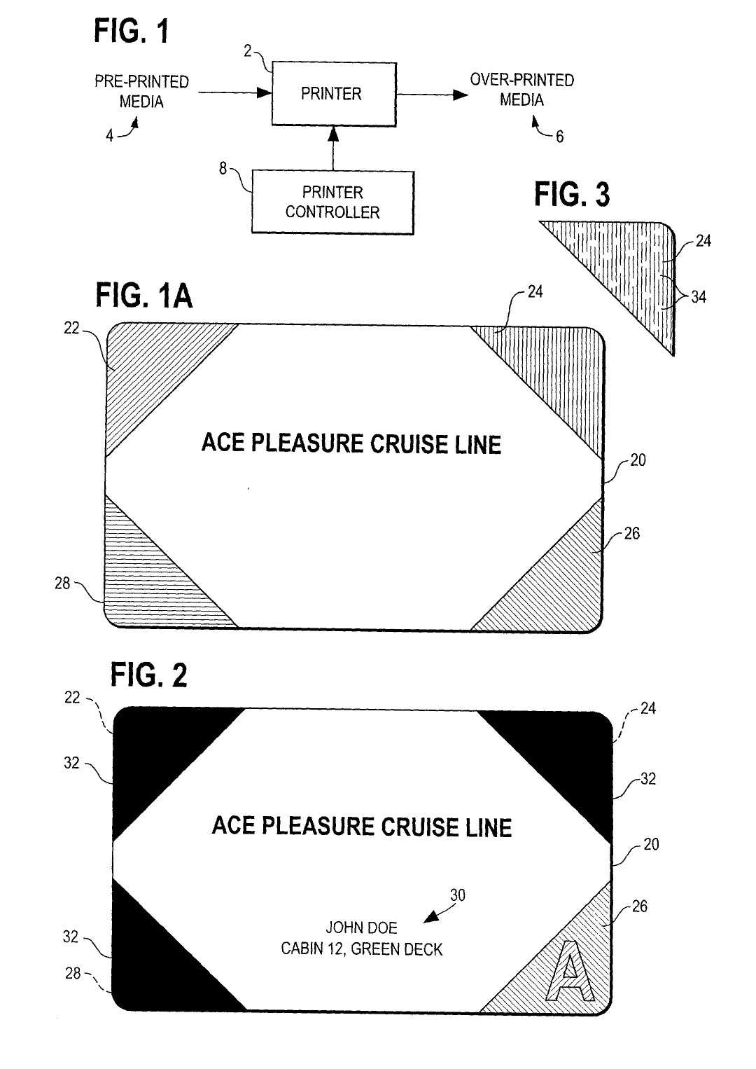

FIG. 1 depicts schematically a printer 2 suitable for accomplishing the objectives of the invention. Printer 2 represents a printer, which may, for example, be a thermal transfer printer employing a monochromatic ribbon, or may be a monochromatic ink jet printer. An input 4 to the printer 2 includes a preprinted tag, label, card or other media having a plurality of areas of different colors. An output 6 of printer 2 includes media overprinted to obscure or otherwise modify selected color areas in such as way as to encode predetermined information. The printer 2 is controlled by a printer controller 8 that is pre-programmed or is programmable.

When a thermal transfer printer is used, the overprinting may be performed with a monochromatic material, for example with a black ink, and preferably by means of a thermal transfer printer employing a monochromatic ribbon. The overprinting is not limited to black, as the overprinting may be accomplished by a ribbon having a single color ink including black and white. In response to the commands from the controller 8 directed to the printer 2, a bank of thermal printing elements transfers the ink from the thermal transfer ribbon to the media to obscure or otherwise modify selected ones of the color elements.

Alternately, the printer 2 may be an ink jet printer employing a monochromatic print head. The overprinting may be black, and may be accomplished by a print head that can deposit black ink.

A specific embodiment of the inventive concept is depicted in FIGS. 1A and 2, which show, by way of example, two stages of the encoding of a label for identifying an article of luggage on a pleasure cruise ship. A label 20 or “media” is shown having a pre-formed pattern of color elements spaced in two dimensions across the media. The elements have a varying shape, orientation, or color to form a pictorial, geometric or other decorative or informative pattern. The encoding of information is accomplished by overprinting to obscure or otherwise modify one or more prescribed color elements to encode first predetermined information, and thus alter the visual geometry of the pattern to encode the information.

FIG. 1A depicts a blank, rectangular media in the form of the label 20 preprinted and ready for encoding, but before attachment to luggage. Attachment may be by means of an adhesive, or the label may be affixed to means for hanging the label from the luggage. The label 20 is shown as having a pattern of color areas or elements in the corners thereof, and wherein a subsequent overprinting will obscure or otherwise modify one or more of the color elements. The color elements are indicated symbolically, with a color 22 at the top left corner indicated as being brown, and in clockwise rotation, the corner colors are red 24, green 26 and blue 28, respectively.

For example, the color green 26 may indicate the top, or “A” deck, and the colors red 24, brown 22, and blue 28 may indicate the “B,” “C” and “D” decks of a ship, respectively.

The label 20 ready for attachment to the luggage is shown by FIG. 2. Indicia, such as the name of the passenger and a location assigned 30, has been printed thereon by means of the printer 2 of FIG. 1.

A bar code (not shown) may also be imprinted on the label to provide additional information. The label 20, or “media” is also shown as having the aforementioned pre-formed pattern of color elements spaced in two dimensions across the media. As indicated above, the elements are brown 22, red 24, green 26, and blue 28 color areas, selected ones of which are shown having been overprinted in black by the same thermal transfer process.

As a result, only the green 26 color area remains visible at the bottom right corner of the label, which as noted, indicates that the luggage is to be routed to the “A” Deck of the cruise ship.

As shown, a symbol may be printed in association with one or more of the unmodified color areas to signify second predetermined information unrelated to the color of the unmodified color area. Such a symbol, e.g., the alpha symbol A” indicated in FIG. 2, is shown in this embodiment as being overprinted in black 32 on the green color element 26 to signify second predetermined information. The symbol is intended to enhance clarity as to the meaning of the color element 26 and as an aid to luggage handlers who may be color blind.

The symbol may also be a numeral, such as the number “4”. Alternatively, the added symbol, whether a letter, a number or other symbol, may indicate a subset of the information provided by the color pattern, such as the “A” section of the green deck denoted.

When a thermal transfer printer is utilized, in response to the commands directed to the printer 2 by printer controller 8, a bank of thermal printing elements transfers the ink from the thermal transfer ribbon to the media to obscure or otherwise modify selected ones of the color elements. Other alphanumeric symbols may also be used, and the shape or pattern may include the human-readable text shown, or a machine-readable symbol. Encoding predetermined information on the label in this manner facilitates the distribution of the luggage because the baggage handlers need not read the fine print on the label. As a result, the handlers can route the luggage more expeditiously by means of the encoded color information.

Further, with regard to the inclusion of the alpha symbol, such as the letter “A,” this addition overcomes the handicap of a luggage handler who may be colorblind and who may be unable to visually identify the association of the green color with the A deck.

In lieu of a full monochromatic overprint of ones of the four colors depicted in the corners of the label of FIG. 1, many additional color options may be provided by partially overprinting the colors. A partial overprinting is shown by FIG. 3, wherein the color red is depicted as being partially overprinted with a white ink in a pattern of dots, which, if a true red color were shown, would produce a color that appears pink. Similarly, techniques, such as half toning, stippling, cross hatching, striping, gray scaling, and visual texturing, or otherwise changing the visual impression of the individual modified color areas, can also be used according to the invention to create darker or lighter shades of the same color, as well as other variations of the same color. For more elaborate color effects, ink-jet printing may supplement thermal transfer printing. A printer that offers both thermal printing and ink-jet printing, and which is suitable for the overprinting described, is the subject of U.S. Pat. No. 6,151,037, of common ownership, and is incorporated by reference herein.

Color coding with this invention may be achieved without the use of a color printed by preprinting all needed colors on the label or tag, and subsequently obscuring or otherwise modifying selected colors with on-demand monochromatic printing means. As a result, color encoding of media according to the invention may faster, less expensive and less cumbersome than if it were performed with a more elaborate color printing apparatus.

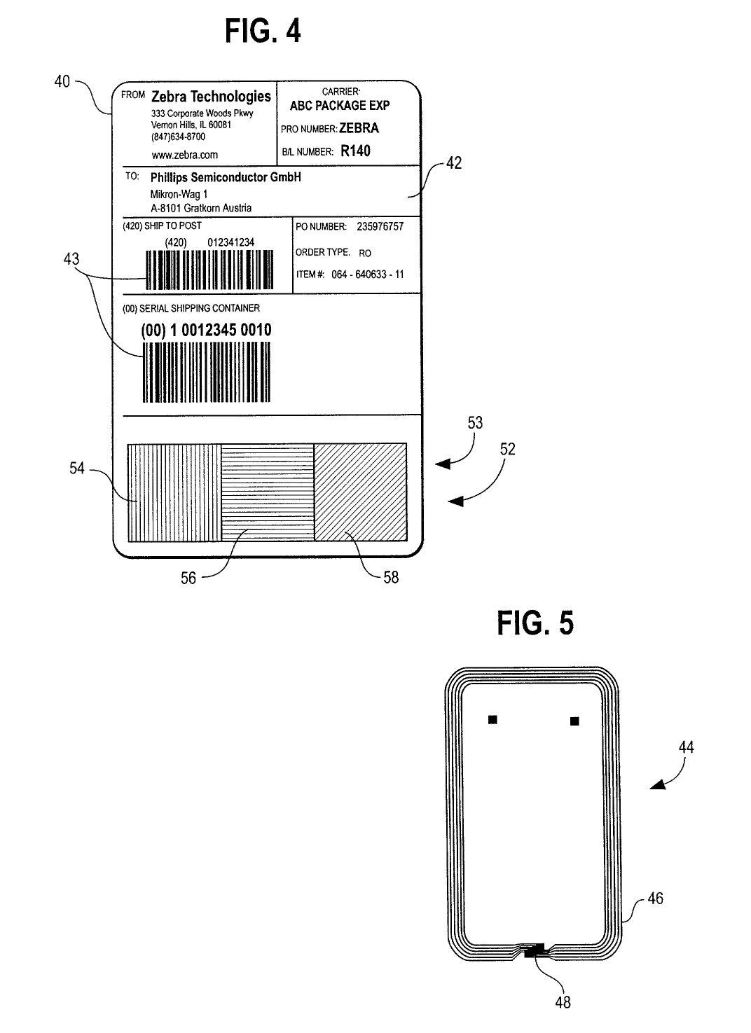

FIG. 4 depicts a label 40 having an RFID transponder with an indicia-receiving surface 42 and at least one bar code 43. As indicated by FIG. 5, an RFID transponder assembly 44 includes an antenna 46 and an interconnected microchip 48, which may be embedded in label 40 by interleaving the assembly 44 into the tiered structure of the label. At an end of the indicia-receiving surface 42 is a pattern 52 of three color elements 53 preprinted on the label, which are shown symbolically from left to right as red 54, blue 56, and brown 58. All or selected ones of the color elements 53 are overprinted in a later process to obscure or otherwise modify selected elements of the pattern 52 to encode predetermined information, as has been described in connection with FIGS. 1-3.

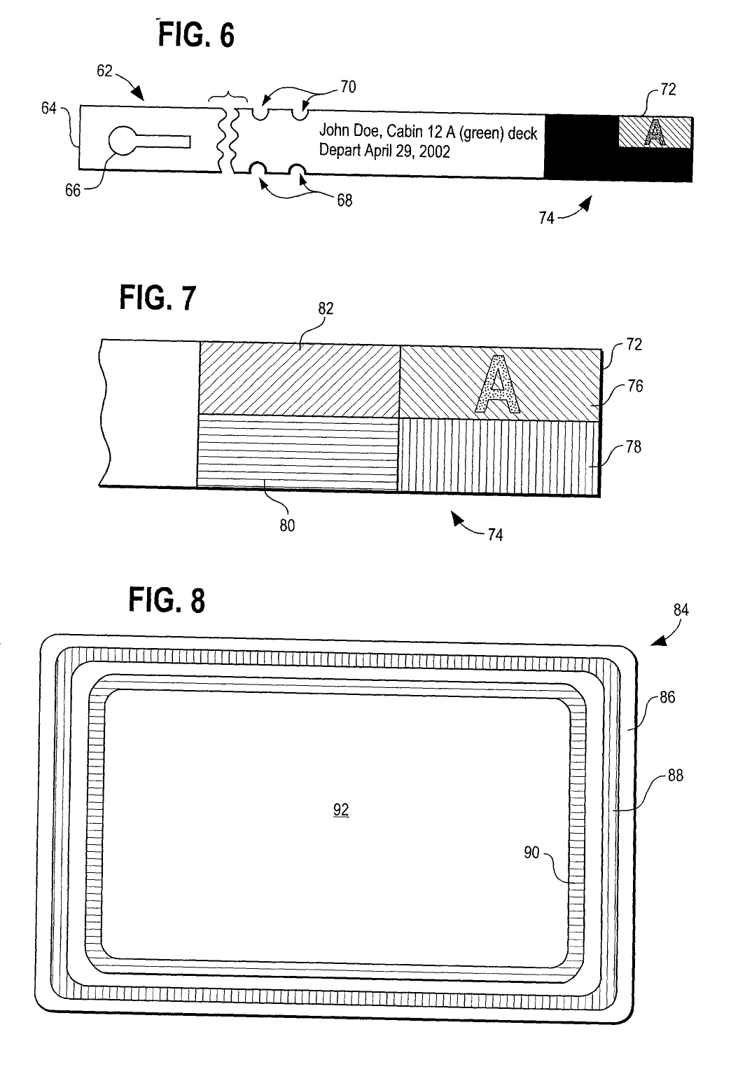

FIG. 6 depicts another embodiment of a luggage label in the form of a luggage hang tag 62 having a first end 64 in which a perforation 66 and intersecting notches 68 and 70 provide for attaching tag 62 to an item of luggage (not shown). A second encoded end 72 of hang tag 62 has a predetermined pattern 74 of colors preprinted thereon.

FIG. 7 is a detailed view of the encoded end 72 of hang tag 62 of FIG. 7, which shows the placement of the pattern 74 of colors before selected ones of the colors of the pattern 74 are obscured or otherwise modified. The colors shown symbolically from top right in a clockwise direction are: green 76, red 78, blue 80 and brown 82. As indicated by the encoded end 72 of hang tag 62 in FIG. 6, the colors red 78, blue 80 and brown 82 of patterns 74 are overprinted in black, thus leaving the green 76 color visible. As before, the green 76 color may indicate a specific deck of the cruise ship. The human-readable alpha symbol “A” is shown as being overprinted on the green color element. In addition to an alphanumeric symbol, the symbol may include a bar code or other machine-readable symbol.

FIG. 8 is depicts another embodiment of the invention wherein the media is represented as a label 84 having a surface 86 with color elements thereon comprising concentric rings of varying colors. In this embodiment, there is an outer ring 88, indicated symbolically as displaying the color red, and a second inner ring 90, symbolically displaying the color blue. There may be several such concentric rings of color. The label 84 is encoded according to the invention by overprinting, which obscures or otherwise modifies one or more of the rings. The central area 92 may have indicia and a bar code thereon. The overprinting may also result in half toning, stippling, cross hatching, striping, texturing or otherwise changing the visual impression of the individual modified color areas.

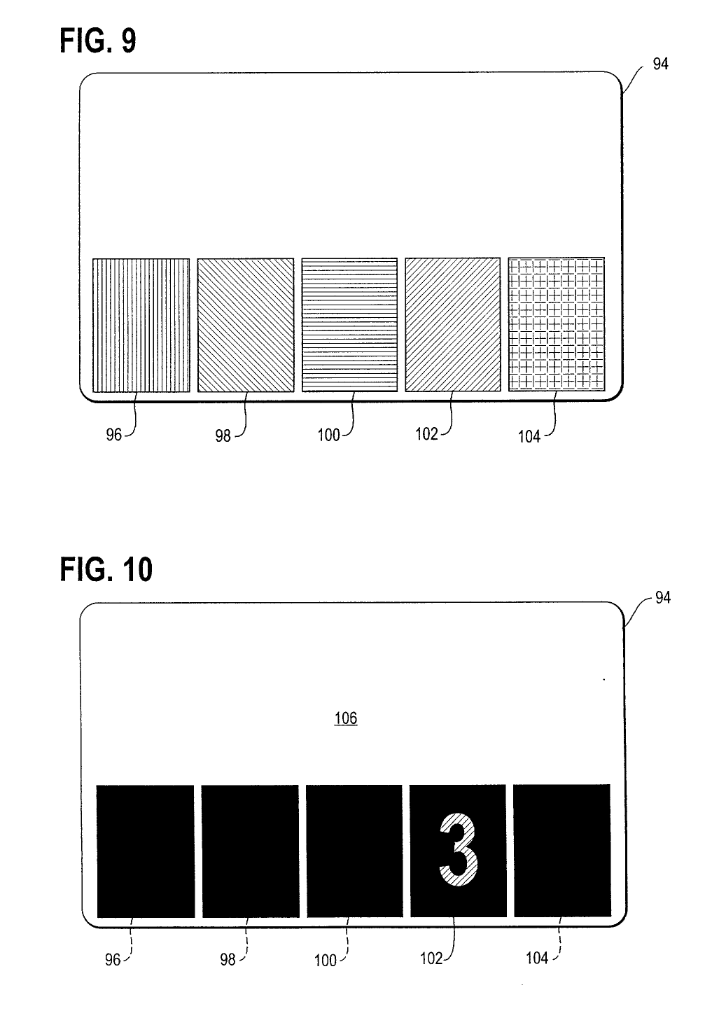

FIG. 9 depicts media, such as a label 94, having at least one color area, and by negative overprinting, masking all but a prescribed shape or pattern on the area. The label 94 has a plurality of color areas including five color areas defined from left to right as follows: red 96, green 98, blue 100, brown 102, and yellow 104. On this plurality of color areas of different colors, negative overprinting is performed on different ones of the color areas to produce shapes or patterns of different colors, with the location of the pattern or shape collectively signifying predetermined information. The overprinting may be performed with a monochromatic material, such as by a thermal transfer ribbon employing a monochromatic ribbon. By overprinting to form a negative mask, selected color elements may be modified to obscure or affect their color and alter the visible rendition produced collectively by the elements.

The result of the overprinting is shown by FIG. 10 where predetermined information is encoded into the label by overprinting the colors red 96, green 98, blue 100 and yellow 104 with black. The color brown 102 is negative overprinted to define the numeral “3.” The numeral “3” is not actually printed onto the label 94. Rather, it is defined by not overprinting a portion of the color brown 102. In this example, all colors except one are modified, and the symbol “3” is marked on or in association with an unmodified color area. The shape or pattern may differ depending upon the color of the color area, and rather than a single numeral or letter, a plurality of color elements may be overprinted, all according to the invention. As an example of a practical application of this embodiment, the predetermined information shown by label 94 may direct a “Truck No. 3” to proceed to an area of a city designated as the “brown” area for delivery of products. Area 106 of label 94, shown as being vacant in FIG. 10, may be printed with indicia and a bar code to indicate further details of the destination, such as the exact location and the name of the recipient.

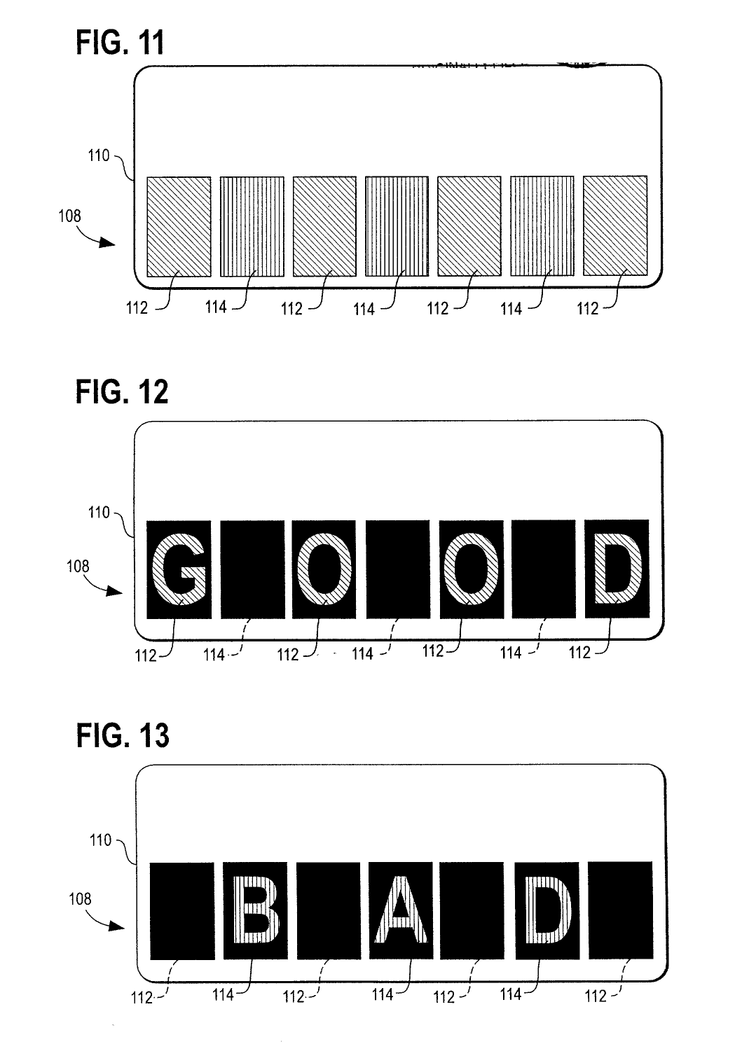

FIGS. 11-13 depict a pattern of color elements that include a plurality of intercalated pattern of elements of different colors, and wherein the overprinting modifies selected elements to obscure or affect their color, and alters the visible rendition produced collectively by the color elements. A plurality of symbols similar to the embodiment of FIG. 9 may form words or terms. In FIG. 11, an intercalated pattern 108 of two different colors, namely green and blue, are shown as being preprinted on a label 110 in an alternating sequence of green 112, red 114, green 112, red 114, green 112, red 114, and green 112.

FIG. 12 shows the effect of the negative overprinting of the four colors green 112 to define the word G-O-O-D in the color green 112. Predetermined information thus encoded into the label may, for example, serve to indicate a favorable operation of a machine under test. Overprinting with black as indicated, masks the three colors red 114. In effect, the overprinting forms a negative mask, which obscures all elements except those having a predetermined color and location characterizing a predetermined collective, color shape, symbol or pattern. It is again noted that imprinting may be performed with a single pass of the media through the printer.

Similarly, FIG. 13 shows the three colors, red 114, negatively overprinted to disclose the letters B-A-D to indicate an adverse, or “red” test condition. In this example, the four colors green 112 are shown as being overprinted with black.

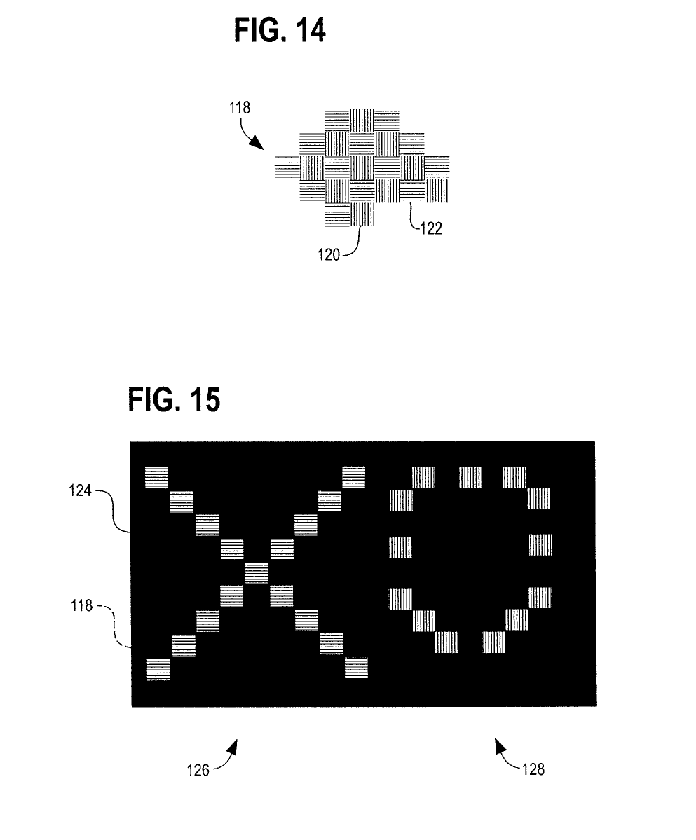

FIGS. 14 and 15 illustrate another embodiment of the encoding of information according to the invention. As indicated in FIG. 14, an underlayment for the encoding includes an intercalated pattern 118 of two color elements with a plurality of colors indicated symbolically as the color red 120 and the color blue 122, each in the form of a square, by way of example.

FIG. 15 depicts a panel 124 with such a pre-formed repeating pattern 118 thereon, and which includes a checkerboard of two or more intercalated color patterns, shown as being two in this example. The panel 124 is overprinted according to the invention to obscure or otherwise modify selected elements in the pattern to encode predetermined information. As shown by FIG. 15, a letter, such as the exemplary letter “X,” 126 appears in blue, which is the result of obscuring or otherwise modifying the red 120 color elements according to the invention. Similarly, obscuring the blue 122 color elements causes another letter, namely the letter “O” 128, for example, to appear in red. Accordingly, numerous characters, each having a different one of the two colors 120 and 122, can be shown within a panel having such a pattern 118 by selective overprinting.

Further, words may be negatively overprinted as described, using all or a select subset of the colored patterns. The patterns may be of any selected color or the same color. Overprinting or otherwise obscuring color elements according to the invention may be accomplished by other means, such as using different colors of ink, such as black ink, white ink, or ink having the same color as the media.

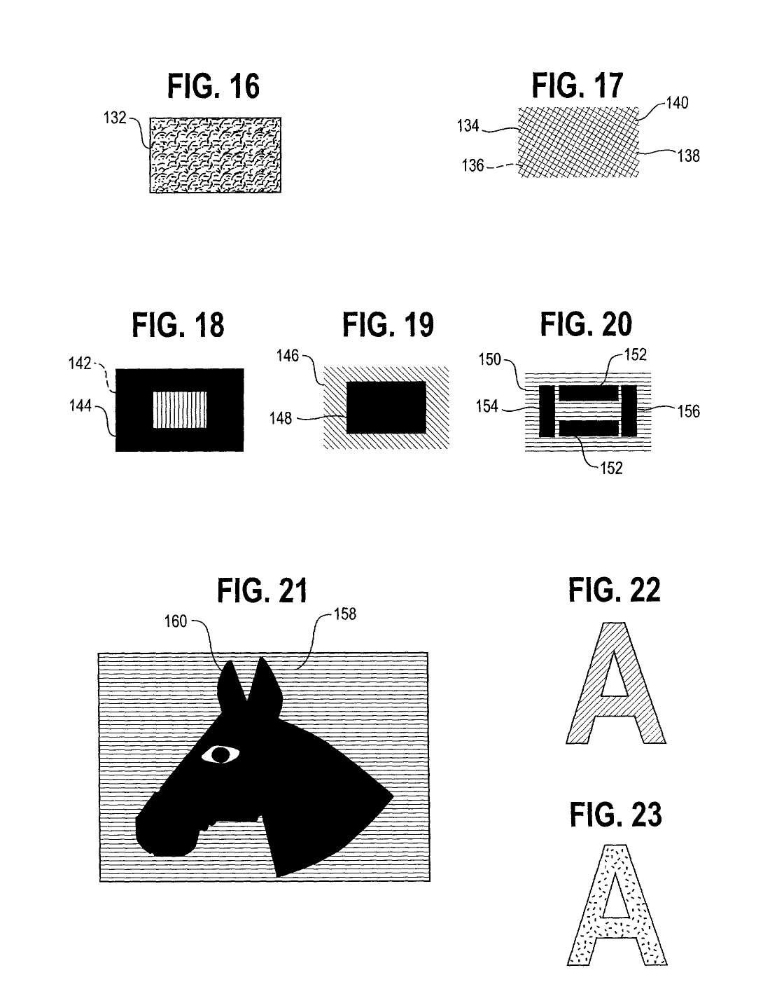

FIG. 16 shows the effect of texturing a field 132. It should be noted that the texturing indicated by FIG. 16 is a “visual” texture or optical texture rather than a tactile texture.

FIG. 17 indicates the effect of a crosshatched field 134 over an underlayment of a field 136 which, by way of example, may be blue (not indicated). The cross-hatching may include left-inclined stripes 138, which may be of any color other than blue, and those overprinted with right-inclined stripes 140 of the same color or a contrary color, all by way of example.

FIGS. 18-20 depict further examples of encoding media by overprinting according to the invention to define arbitrary signs and symbols. With regard to FIG. 18, a preprinted field of red 142 is indicated as being negative overprinted with black 144 to define a rectangular center field of red. FIG. 19 depicts a preprinted field of green 146 with an overprinting that defines a rectangular center field of black 148. Similarly, FIG. 20 depicts a field of blue 150 with a center pair of horizontally oriented rectangular black symbols 152 flanked by a pair of vertically oriented rectangular black symbols 154 and 156. The scope of the invention is not limited to rectangles or any other specific geometric shape. The arbitrarily selected symbols may be squares, rectangles, circles, triangles, oblongs, or any combination thereof

Pictorial effects can be achieved by negative overprinting according to the invention. With reference to FIG. 21 and with respect to the previous example of identifying the deck location to which luggage is to be sent on a cruise ship, luggage intended for the blue “B” deck may be indicated on an attached luggage tag (not shown) having preprinted thereon a field of blue 158. The field of blue 158 is shown as having overprinted thereon a pictorial of a horse 160, for example, signifying the “horse deck” as an aid to memory.

With regard to the symbols, such as the symbol “A” defined previously, and all alphanumeric symbols as well as those described herein as being human-readable or machine-readable, such symbols may also be distinguished by stippling, half toning, cross-hatching, striping or texturing or otherwise changing the visual impression of the individual modified color areas. The alpha letters “A” shown by FIGS. 22 and 23 are examples, wherein FIG. 22 is indicated symbolically as having overprinted thereon the color green. The alpha letter “A” shown by FIG. 23 is distinguished by stippling.

While particular embodiments of the present invention have been shown and described, it will be readily apparent to those skilled in the art that changes and modifications may be made without departing from the invention in its broader aspects. Therefore, the appended claims are intended to cover all such changes and modifications as fall within the true spirit and scope of the invention. The matter set forth in the foregoing description and accompanying drawings is offered by way of illustration only and not as a limitation as to the scope of the invention.

What is claimed is:

1. A method of encoding information, comprising:
a. providing a tag, label, card or other media having a pattern of color elements spaced in two dimensions across the media, said elements having varying shape, orientation, or color to form a pictorial, geometric or other decorative or informative pattern; and
b. overprinting the media to obscure or otherwise modify predetermined elements of said pattern to alter a visual geometry or color of the pattern so as to encode predetermined information.

2. The method defined by claim 1 wherein at least selected ones of said elements are different colors.

3. The method defined by claim 1 wherein said tag, label, card or other media includes an RFID transponder or a bar code.

4. The method defined by claim 1 wherein said elements include alphanumeric symbols.

5. The method defined by claim 1 wherein said overprinting is performed by at least one of a monochromatic thermal transfer printer employing a monochromatic ribbon and an ink jet printer employing a monochromatic printer head.

6. The method defined by claim 1 wherein said pattern include colored elements in corners of a rectangular media, and wherein said overprinting obscures or otherwise modifies at least one of said corner elements.

7. The method defined by claim 1 wherein said elements include concentric rings of varying colors, and wherein said overprinting obscures or otherwise modifies one or more of said rings.

8. The method defined by claim 1 wherein said overprinting results in at least one of half-toning, stippling, cross-hatching, striping, texturing or otherwise changing a visual impression of the predetermined elements so modified.

9. A method of encoding information, comprising:
a. providing a tag, label, card or other media having at least one color area; and
b. negative overprinting said color area to mask all but a predetermined shape or pattern on said area.

10. The method defined by claim 9 wherein said tag, label, card or other media includes an RFID transponder or a bar code.

11. The method defined by claim 9 wherein said tag, label, card or other media has a plurality of color areas of different colors, and wherein said negative overprinting is performed on different ones of said color areas to produce shapes or patterns of different colors, said colors, said shapes or said patterns, and a location of said shapes or patterns collectively signifying predetermined information.

12. The method defined by claim 9 wherein said shape or pattern includes a human-readable or a machine-readable symbol.

13. The method defined by claim 9 wherein the shape or pattern differs depending upon the color of the color area.

14. The method defined by claim 9 wherein a plurality of said color areas are negative overprinted.

15. The method defined by claim 9 wherein said negative overprinting forms an alphanumeric symbol.

16. The method defined by claim 11 wherein said plurality of areas of different color form predetermined words or terms.

17. The method defined by claim 11 wherein said plurality of areas of different color have shapes or patterns preprinted on said media.

18. The method defined by claim 11 wherein said shapes or patterns formed by said overprinting coincide with said shapes or patterns preprinted on said media.

19. The method defined by claim 11 wherein said shapes or patterns formed by said overprinting differ from said shapes or patterns preprinted on said tag, label, card or other media.

20. A method of encoding information, comprising:
a. providing a tag, label, card or other media having a plurality of areas of different colors; and
b. overprinting the tag, label, card or other media to obscure or otherwise modify one or more predetermined color areas to encode first predetermined information, and printing a symbol in association with one or more unmodified color areas to signify second predetermined information unrelated to the color of the unmodified color area.

21. The method defined by claim 20 wherein said overprinting is performed with a monochromatic material.

22. The method defined by claim 20 wherein said overprinting is performed with a thermal transfer printer employing a monochromatic ribbon.

23. The method defined by claim 20 wherein said symbol includes at least one of an alphanumeric symbol, a barcode symbol and a machine-readable symbol.

24. The method defined by claim 20 wherein said tag, label, card or other media includes an RFID transponder or a bar code.

25. The method defined by claim 20 wherein all of said color areas except one are modified, and wherein said symbol is marked on or in association with an unmodified color area.

26. The method defined by claim 20 wherein said modification includes at least one of half toning, stippling, cross-hatching, striping, or texturing and otherwise changing a visual impression of the individual modified color areas.

27. A method of encoding information comprising:
a. providing a tag, label, card or other media having a repeating pattern of two or more color elements; and
b. overprinting the tag, label, card or other media to obscure or otherwise modify selected elements in said pattern to encode predetermined information.

28. The method defined by claim 27 wherein said repeating pattern includes intercalated color patterns.

29. The method defined by claim 27 wherein said pattern of color elements includes a plurality of intercalated patterns of elements of different colors, and wherein said overprinting modifies selected elements to obscure or affect their color, and alters a visible rendition produced collectively by the color elements.

30. The method defined by claim 27 wherein said overprinting forms a negative mask which obscures all elements except those having a predetermined color and location defining a predetermined collective color shape, symbol or pattern.

31. The method defined by claim 28 wherein said repeating pattern includes a checkerboard of two or more intercalated color patterns.

32. The method defined by claim 27 wherein said tag, label, card or other media includes an RFID transponder or a bar code.

33. A method of encoding information comprising:
a. providing a blank tag, label, card or other media;
b. printing a pattern of color areas on said media;
c. in a thermal transfer printer, providing a monochromatic thermal transfer ribbon ink on a ribbon; and
d. in response to printer commands, employing a bank of thermal elements to transfer said ribbon ink from said ribbon to said media to obscure or otherwise modify selected ones of said color areas.

34. The method defined by claim 33 wherein said tag, label, card or other media includes an RFID transponder or a bar code.

35. The method defined by claim 33 wherein said color areas include alphanumeric text.

36. A method of encoding information comprising:
a. providing a tag, label, card or other media having an RFID transponder and at least one color element; and
b. overprinting the tag, label, card or other media to obscure or otherwise modify said color element.

37. The method defined by claim 36 wherein said media has a plurality of elements of different colors.

38. A tag, label, card or other media having an RFID transponder or bar code, and one or more color areas which have been selectively obscured, partially obscured or otherwise modified with a monochromatic ink or other material to encode information.

39. A tag, label, card or other media having a pre-formed pattern of color elements spaced in two dimensions across the media, said elements having varying shape, orientation, or color to form a pictorial, geometric or other decorative pattern, said media having been overprinted to obscure or otherwise modify predetermined elements of said pattern to alter a visual geometry or color of the pattern so as to encode predetermined information.

40. The tag, label, card or other media defined by claim 39 including an RFID transponder or a bar code.

41. The tag, label, card or other media defined by claim 39 wherein said pattern includes colored elements in corners of a rectangular media, and wherein said overprinting obscures or otherwise modifies one or more of said corners.

42. A tag, label, card or other media having at least one pre-formed color area upon which has been negative overprinted to mask all but a predetermined shape or pattern on said area, the shape or pattern encoding predetermined information.

43. The tag, label, card or other media defined by claim 42 including an RFID transponder or a bar code.

44. The tag, label, card or other media of claim 42 further including a plurality of areas of different colors, and wherein said negative overprinting is located on different ones of said color areas to produce shapes or patterns of different colors, said color, said shape or pattern, and a location of said shape or pattern, collectively signifying predetermined information.

45. The tag, label, card or other media defined by claim 42 wherein said shape or pattern includes at least one of a human-readable symbol, a barcode, and a machine-readable symbol.

46. A tag, label, card or other media having a plurality of pre-formed areas of different colors overprinted to obscure or otherwise modify one or more predetermined color areas to encode first predetermined information, said overprinting including a symbol in association with one or more unmodified color areas to signify second predetermined information unrelated to the unmodified color area.

47. The tag, label, card or other media defined by claim 46 wherein said symbol includes an alphanumeric, a barcode or machine-readable symbol.

48. The tag, label, card or other media defined by claim 46 wherein said media includes an RFID transponder or a barcode.

49. A tag, label, card or other media having a pre-formed repeating pattern of two or more color elements overprinted to obscure or otherwise modify selected elements in said pattern to encode predetermined information.

50. The tag, label, card or other media defined by claim 49 wherein said pre-formed repeating pattern includes intercalated color patterns.

51. The tag, label, card or other media defined by claim 49 wherein said pre-formed repeating pattern of color elements includes a plurality of intercalated patterns of elements of different colors, and wherein said overprinting modifies selected elements to affect the color and a shape produced collectively by the unmodified color elements.

52. The tag, label, card or other media defined by claim 49 wherein said pre-formed repeating pattern includes a checkerboard of two or more intercalated color patterns.

53. The tag, label, card or other media defined by claim 49 further including an RFID transponder or a bar code.

54. A tag, label, card or other media having an RFID transponder and one or more preformed color areas adapted to be selectively obscured, partially obscured, or otherwise modified with monochromatic ink or other material to encode information.

55. A tag, label, card or other media having a pre-formed pattern of color elements spaced in two dimensions across the media, said elements having varying shape, orientation, or color to form a pictorial, geometric or other decorative pattern, said media being adapted to be overprinted to obscure, partially obscure or otherwise modify predetermined elements of said pattern to alter a visual geometry or color of the pattern to encode predetermined information.

56. The tag, label, card or other media defined by claim 55 further including an RFID transponder or a bar code.

57. The tag, label, card or other media defined by claim 55 herein said pattern includes colored elements in at least one corner of a rectangular media, at least one of said corners obscured, partially obscured or otherwise modified by said overprinting.

58. A tag, label, card or other media having a pre-formed repeating pattern of two or more color elements adapted to be overprinted to obscure or otherwise modify selected elements in said pattern to encode predetermined information.

59. The tag, label, card or other media defined by claim 58 wherein said pre-formed repeating pattern includes intercalated color patterns.

60. The tag, label, card or other media defined by claim 58 wherein said pre-formed repeating pattern includes a checkerboard of two or more intercalated color patterns.

61. The tag, label, card or other media defined by claim 58 including an RFID transponder or a bar code.

62. A system of encoding information comprising:
a. as an input—a tag, label, card or other media having a pattern of color elements spaced in two dimensions across the media, said elements having varying shape, orientation, or color to form a pictorial, geometric or other decorative pattern;
b. a printer; and
c. as an output, the tag, label, card or other media being overprinted to obscure or otherwise modify predetermined elements of said pattern to alter a visual geometry or color of the pattern to encode predetermined information.

63. The system defined by claim 62 wherein at least selected elements have different colors.

64. The system defined by claim 62 wherein said media includes an RFID transponder or a bar code.

65. The system defined by claim 62 wherein said elements include alphanumeric text.

66. The system defined by claim 62 wherein said overprinting is performed with a thermal transfer printer employing a monochromatic ribbon.

67. A system of encoding information, comprising:
a. as an input—a tag, label, card or other media having a plurality of areas of different colors;
b. a printer; and
c. as an output, the tag, label, card or other media being overprinted to obscure or otherwise modify one or more predetermined color areas to encode first predetermined information, and overprinted with a symbol in association with one or more color areas to define second predetermined information.

68. The system defined by claim 67 wherein said tag, label, card or other media is overprinted with a monochromatic material.

69. The system defined by claim 67 wherein said printer is a thermal transfer printer employing a monochromatic ribbon.

70. The system defined by claim 67 wherein said symbol includes an alphanumeric or machine-readable symbol.

71. The system defined by claim 67 wherein said tag, label, card or other media includes an RFID transponder.

72. A system of encoding information comprising:
a. as an input—a tag, label, card or other media having a pre-formed repeating pattern of two or more color elements;
b. a printer; and
c. as an output, the tag, label, card or other media being overprinted to obscure or otherwise modify selected elements in said pattern to encode predetermined information.

73. The system defined by claim 72 wherein said pre-formed repeating pattern includes intercalated color patterns.

74. The system defined by claim 72 wherein said pre-formed repeating pattern of color elements includes a plurality of intercalated patterns of elements of different colors, and wherein said overprinting modifies selected elements to obscure or affect their color, and alters a visible rendition produced collectively by the color elements.

75. The system defined by claim 72 wherein said overprinting forms a negative mask which obscures all elements except those having a predetermined color and location defining a predetermined collective color shape, symbol or pattern.

76. The system defined by claim 72 wherein said pre-formed repeating pattern includes a checkerboard of two or more intercalated color patterns.

77. For use with a tag, label, card or other media having a pattern of color elements spaced in two dimensions across the media, said elements having varying shape, orientation, or color to form a pictorial, geometric or other decorative pattern, a printer programmed or programmable to overprint the media to obscure or otherwise modify predetermined elements of said pattern to alter the visual geometry or color of the pattern so as to encode predetermined information.

78. The printer defined by claim 77 wherein said tag, label, card or other media includes an RFID transponder or a bar code.

79. The printer defined by claim 77 wherein said printer is a thermal transfer printer employing a monochromatic ribbon.

80. For use with a tag, label, card or other media having a plurality of areas of different colors, a printer programmed or programmable to overprint media to obscure or otherwise modify one or more predetermined color areas to encode first predetermined information, and to overprint the tag, label, card or other media with a symbol in association with one or more color areas to define second predetermined information.

81. The printer defined by claim 80 wherein said printer is a thermal transfer printer employing a monochromatic ribbon.

82. The printer defined by claim 80 wherein said media includes an RFID transponder or bar code.

83. For use with a tag, label, card or other media having a pre-formed repeating pattern of two or more color elements, a printer programmed or programmable to overprint the tag, label, card or other media to obscure or otherwise modify selected elements in said pattern to encode predetermined information.

84. The printer defined by claim 83 wherein said pre-formed repeating pattern includes intercalated color patterns.

85. The printer defined by claim 83 wherein said pre-formed pattern of color elements includes a plurality of intercalated patterns of elements of different colors, and wherein said overprinting modifies selected elements to obscure or affect their color, and alters a visible rendition produced collectively by the color elements.

86. The printer defined by claim 83 wherein said pre-formed repeating pattern includes a checkerboard of two or more intercalated color patterns.
